(19) United States
(12) Patent Application Publication
(10) Pub. No.: US 2010/0333040 A1
(43) Pub. Date: Dec. 30, 2010

(54) AIRCRAFT SPECIAL NOTICE DISPLAY SYSTEM AND METHOD

(75) Inventors: Dhivagar PALANISAMY, Perundurai (IN); Vishnu Vardhan Reddy ANNAPUREDDY, Bangalore (IN); Saravanakumar GURUSAMY, Coimbatore (IN); Santhosh GAUTHAM, Bangalore (IN)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/495,394

(22) Filed: Jun. 30, 2009

(51) Int. Cl. G06F 3/048

(52) U.S. Cl. 715/854

(57) ABSTRACT

Methods and apparatus are provided for selectively displaying special notices on a display device. Navigation data are selectively retrieved and processed, and a determination is made if at least a portion of the retrieved navigation data has special notice data associated therewith. An image is rendered on a display device that is representative of at least a portion of the retrieved navigation data, and that includes a special notice icon if it is determined that at least a portion of the retrieved navigation data has special notice data associated therewith. The special notice data are representative of special notices normally published in an airport facility/directory

### TECHNICAL FIELD

The present invention generally relates to aircraft displays, and more particularly relates to a system and method for making aircraft flight crews aware of, and displaying, special notices that are normally published in one or more flight-related publications.

### BACKGROUND

Prior to take-off, an aircraft flight crew typically engages in various pre-flight briefings. These briefings include reviewing weather conditions along the planned route, reviewing an NOTAMs (NOtices To AirMen) associated with the take-off and landing airport, and other relevant information associated with the flight. In many instances, relevant information may be included in what are generally referred to as “Special Notices,” which are published in a SPECIAL NOTICE section of a publication that is entitled the Airport Facility/Directory (AF/D).

The AF/D is a manual, published every 8 weeks, that provides comprehensive information regarding airports, communications, navigation aids, and other pertinent information, such as the above-mentioned Special Notices. The types of information provided in Special Notices are typically not provided on airport terminal charts and include, among other things, restricted area transition procedures, lights out operation in certain airports, noise abatement procedures for certain airports, parachute jumping areas, and LTAN (Low Altitude Tactical Navigation Area), to name a few.

Unfortunately, the not all AF/D entries reference a related Special Notice. For example, there may be multiple Special Notices associated with a particular airport or airspace. However, some AF/D airport entries do not include a reference to all of the Special Notices associated with that particular airport. In such instances, a pilot may not be aware that one or more Special Notices were published, and should thus be referenced. Hence, there is a chance that such information could go unnoticed, which is undesirable.

Hence, there is a need for a system and method of automatically alerting aircraft flight crews to the existence of, and displaying, special notices that are normally published in one or more flight-related publications. The present invention addresses at least this need.

### BRIEF SUMMARY

In one embodiment, a method of selectively displaying special notices on a display device includes selectively retrieving and processing navigation data, and determining if at least a portion of the retrieved navigation data has special notice data associated therewith. An image is rendered on a display device that is representative of at least a portion of the retrieved navigation data, and that includes a special notice icon if it is determined that at least a portion of the retrieved navigation data has special notice data associated therewith. The special notice data are representative of special notices normally published in an airport facility/directory.

In another embodiment, a display system includes a display device and a processor. The display device is coupled to receive image rendering display commands and is operable, in response thereto, to render an image. The processor is adapted to selectively retrieve navigation data and is configured to determine if at least a portion of the retrieved navigation data has special notice data associated therewith. The processor further configured to supply image rendering display commands to the display device that cause the display device to render an image that is representative of at least a portion of the retrieved navigation data, and that includes a special notice symbol if it is determined that at least a portion of the retrieved navigation data has special notice data associated therewith. The special notice data are representative of special notices normally published in airport facility and directory books.

Furthermore, other desirable features and characteristics of the method and system will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary display system; and

FIGS. 2-8 depict various images that may be rendered on a display device of the system of FIG. 1 to alert a flight crew regarding special notices.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, it should be understood that the system and method described herein may be implemented in the context of an aircraft flight deck or in the context of an electronic flight bag.

The present invention may be described in terms of functional block diagrams and various processing steps. It should be appreciated that such functional blocks may be realized in many different forms of hardware, firmware, and/or software components configured to perform the various functions. For example, the present invention may employ various integrated circuit components, e.g., memory elements, digital signal processing elements, look-up tables, and the like, which may carry out a variety of functions under the control of one or more microprocessors or other control devices. Such general techniques are known to those skilled in the art and are not described in detail herein. Moreover, it should be understood that the exemplary process illustrated may include additional or fewer steps or may be performed in the context of a larger processing scheme. Furthermore, the various methods presented in the drawing Figures or the specification are not to be construed as limiting the order in which the individual processing steps may be performed. It should be appreciated that the particular implementations shown and described herein are illustrative of the invention and its best mode and are not intended to otherwise limit the scope of the invention in any way.

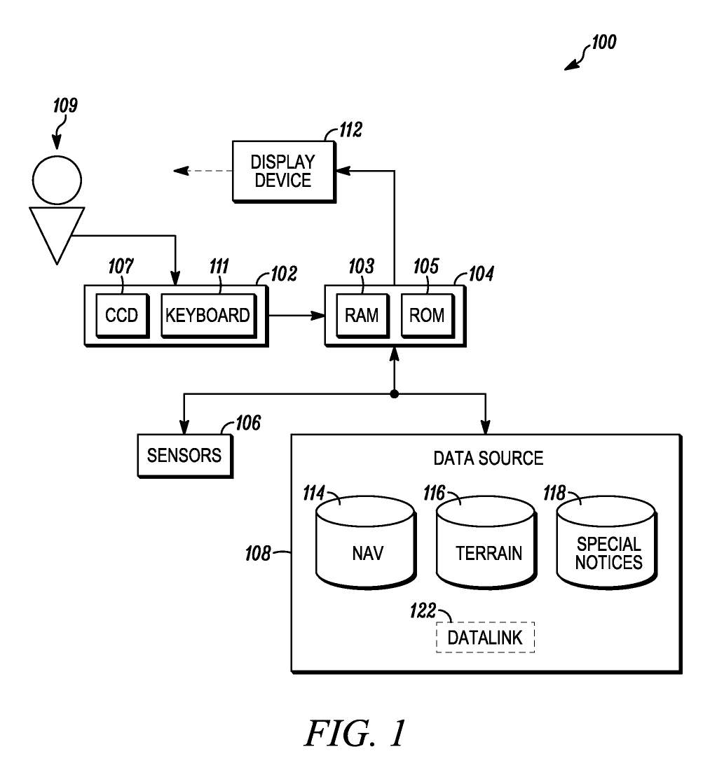

Turning now to FIG. 1, an exemplary display system is depicted and will be described. The system 100 includes a user interface 102, a processor 104, various sensors 106, a data source 108, and a display device 112. The user interface 102 is in operable communication with the processor 104 and is configured to receive input from a user 109 (e.g., a pilot) and, in response to the user input, supply signals to the processor 104. The user interface 102 may be any one, or combination, of various known user interface devices including, but not limited to, a cursor control device (CCD) 107, such as a mouse, a trackball, or joystick, and/or a keyboard, one or more buttons, switches, or knobs. In the depicted embodiment, the user interface 102 includes a CCD 107 and a keyboard 111. The user 109 uses the CCD 107 to, among other things, move a cursor symbol on a display screen and select various images rendered thereon, and may use the keyboard 111 to, among other things, input textual data.

The processor 104 may be any one of numerous known general-purpose microprocessors or an application specific processor that operates in response to program instructions. In the depicted embodiment, the processor 104 includes on-board RAM (random access memory) 103, and on-board ROM (read only memory) 105. The program instructions that control the processor 104 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 104 may be implemented using various other circuits, not just a programmable processor. For example, digital logic circuits and analog signal processing circuits could also be used. Moreover, the processor 104 may include, or implement the functionality of, a graphics processor.

No matter how the processor 104 is specifically implemented, it is in operable communication with the sensors 106, the data source 108, and the display device 112. The processor 104 is configured to receive various types of inertial data and various other avionics-related data from the sensors 106, to selectively retrieve data from the data source 108, and to supply appropriate display commands to the display device 112. The display device 112, in response to the display commands, selectively renders various types of textual, graphic, and/or iconic information. The preferred manner in which the textual, graphic, and/or iconic information are rendered by the display device 112 will be described in more detail further below. Before doing so, however, a brief description of the sensors 106 and the data source 108, at least in the depicted embodiment, will be provided.

The sensors 106 may be implemented using various types of inertial sensors, systems, and or subsystems, now known or developed in the future, for supplying various types of inertial data and avionics-related data. The inertial data may also vary, but preferably include data representative of the state of the aircraft such as, for example, aircraft speed, heading, altitude, and attitude. The avionics-related data may also vary, but preferably includes at least aircraft position, which may be supplied from, for example, a global position system (GPS) receiver.

The data source 108 may be variously implemented, but in the depicted embodiment it is implemented using a plurality of databases, each having various types of data stored therein. The databases that comprise the data source 108 include a terrain database 114, a navigation database 116, and a special notice database 118. The types of data stored in each of these databases 114, 116, 118 will be described. Before doing so, however, it is noted that, although these databases 114, 116, 118 are, for clarity and convenience, shown as being stored separate from the processor 104, all or portions of any or all of these databases 114, 116, 118 could be loaded into the RAM 103, or integrally formed as part of the processor 104, and/or RAM 103, and/or ROM 105. The terrain database 114, navigation database 116, and special notice database 118 could also be part of one or more devices or systems that are physically separate from the system 100.

The terrain database 114 has stored therein various types of data representative of the terrain over which the aircraft is (or will be) flying. The processor 104, upon retrieval of terrain data from the terrain database 114, is configured to process the retrieved terrain data and supply image rendering display commands to the display device 112 that cause the display device to render an image representative of at least a portion of the processed terrain data. The image representative of the processed terrain data may vary. For example, the rendered image may be a two-dimensional lateral view of the terrain, a two-dimensional vertical profile view of the terrain, or a three-dimensional perspective view of the terrain, just to name a few.

The navigation database 116 has stored therein various types of navigation-related data. These navigation-related data include various flight plan related data such as, for example, waypoints, distances between waypoints, headings between waypoints, data related to different airports, navigational aids, obstructions, airspace, political boundaries, communication frequencies, and aircraft approach information. The processor 104, upon retrieval of navigation-related data from the navigation database 116, is configured to process the retrieved navigation data and supply image rendering display commands to the display device 112 that cause the display device to render one or more images representative of at least a portion of the processed navigation data. As will also be described below, the one or more images representative of at least a portion of the processed navigation data are rendered simultaneously with, and preferably overlie, the rendered terrain image.

The special notices database 118 has stored therein various special notice data. These special notice data include data representative of special notices that are normally published in the airport facility/directory (AF/D). It is noted that in some embodiments these data may also include data that associates special notice data with various terrain data stored in the terrain database 114 and/or various navigation-related data stored in the navigation database 116. In such embodiments, whenever the processor 104 retrieves terrain data and/or navigation-related data, the processor 104 queries the special notices database 118 to determine if any special notice data are associated with the retrieved data and, if so, retrieves the associated special notice data from the special notices database 118. In other embodiments, the terrain data and/or navigation-related data may include data that associates it with special notice data. In such embodiments, whenever the processor 104 retrieves terrain data and/or navigation-related data, the processor 104 processes the retrieved data to determine if any special notice data are associated therewith and, if so, retrieves the associated special notice data from the special notices database 118.

Before proceeding further it is noted that in some embodiments the data source may be implemented without the special notices database 118. In such embodiments, the special notice data may be stored remotely, and supplied to the aircraft (or electronic flight bag) in real-time via an aircraft data link 122. It will additionally be appreciated that for those embodiments that do include the above-described special notices database 118, the aircraft data link 122 may be used, if needed or desired, to update the special notice data in real-time.

The display device 112, as noted above, in response to image rendering display commands supplied from the processor 104, selectively renders various textual, graphic, and/or iconic information, and thereby supplies visual feedback to the user 109. It will be appreciated that the display device 112 may be implemented using any one of numerous known display devices suitable for rendering textual, graphic, and/or iconic information in a format viewable by the user 109. Non-limiting examples of such display devices include various cathode ray tube (CRT) displays, and various flat panel displays such as various types of LCD (liquid crystal display) and TFT (thin film transistor) displays. The display device 112 may additionally be implemented as a panel mounted display, a HUD (head-up display) projection, or any one of numerous known technologies. It is additionally noted that the display device 112 may be configured as any one of numerous types of aircraft flight deck displays. For example, it may be configured as a primary flight display (PFD), a horizontal situation indicator, or a vertical situation indicator, just to name a few. In the depicted embodiment, however, the display device 112 is configured as a multi-function display (MFD) that is displaying a lateral situation view.

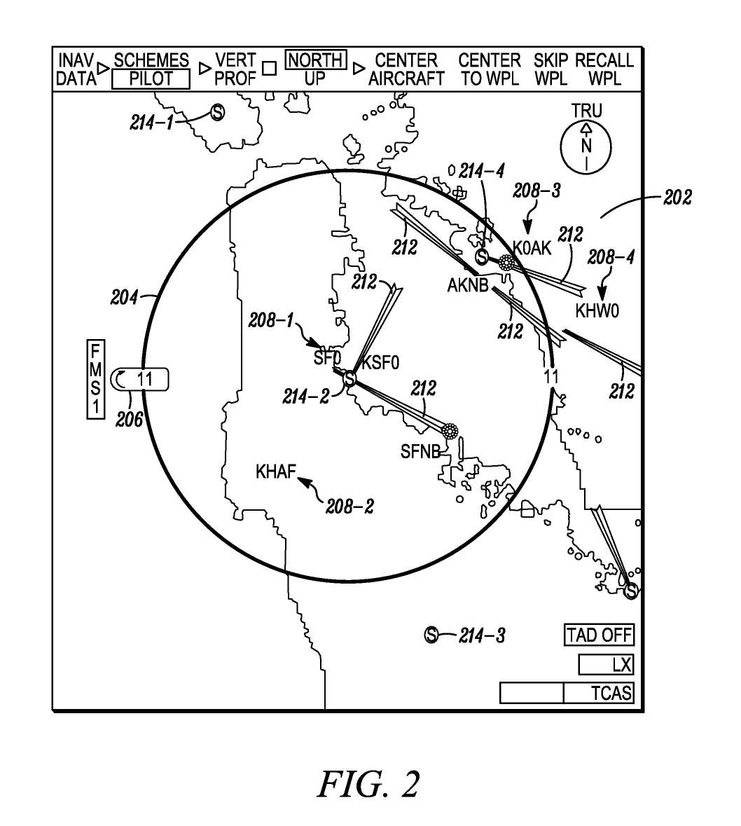

With reference now to FIG. 2, an example image that includes exemplary textual, graphical, and/or iconic information rendered by the display device 112, in response to appropriate image rendering display commands from the processor 104 is depicted. It is seen that the display device 112 simultaneously renders an image of a two-dimensional lateral situation view of terrain 202, various navigation aids, and various other information that will not be further described. It is noted that the rendered image is merely exemplary, and is provided herein for clarity and ease of illustration and description. Indeed, the image could be rendered without terrain, or as a vertical situation view (with or without terrain), or as a perspective, three-dimensional view of the aircraft flight path (with or without terrain), just to name a few non-limiting alternatives.

The navigation aids that are rendered may also vary, but in FIG. 2 these include a range ring 204 and associated range indicator 206, icons representative of various airports 208 (e.g., 208-1, 208-2, 208-3, 208-4), and various ILS feather icons 212 associated with each of the various airports 208. It will be appreciated that the navigation aids that are rendered may vary, and that additional navigation aids may be rendered on the display device 112 if, for example, the geographic region represented by the terrain data differs. It will additionally be appreciated that the rendered terrain 202 is representative of terrain data retrieved from the terrain database 114, and the rendered navigation aids are representative of navigation-related data retrieved from the navigation database 116.

As FIG. 2 also depicts, the image 200 rendered on the display device 112 may also include one or more special notice symbols 214. It is seen that the image 200 depicted in FIG. 2 is rendered with four special notice symbols 214 (e.g., 214-1, 214-2, 214-3, 214-4) at four different geographical locations, which indicates there are one or more special notices associated with the rendered terrain 202, airspace, and/or airports 208 (or other navigation aids). It will be appreciated that the specific manner in which a special notice symbol 214 is rendered may vary, and that the manner in which it is depicted as being rendered in FIG. 2 (and all other drawings herein) is merely exemplary of one embodiment.

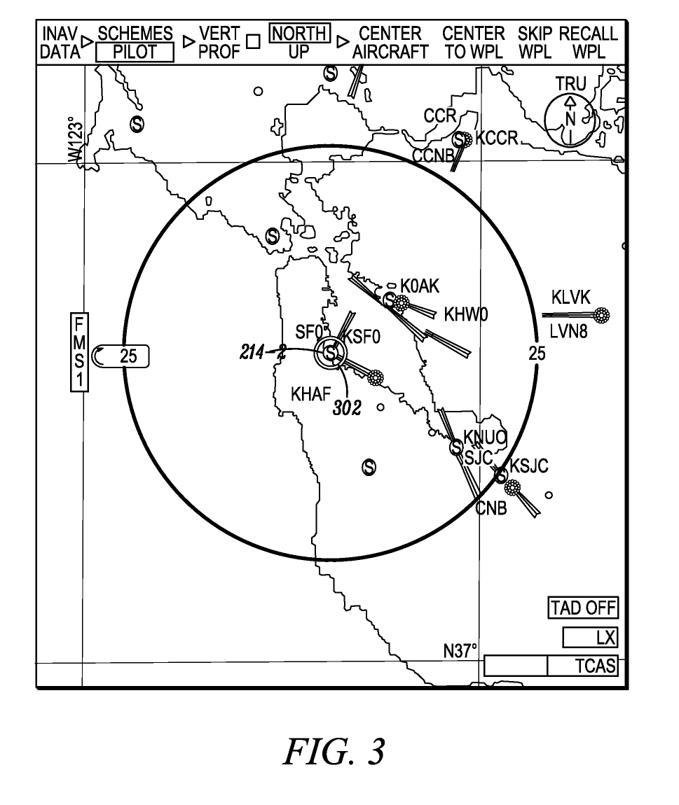

The special notice symbols 214, in addition to being rendered when appropriate, are preferably rendered as interactive images. That is, as illustrated more clearly in FIG. 3, if the user 109 moves a cursor symbol 302 over at least a portion of a rendered special notice symbol 214, the processor 104 may be configured to, for example, supply image rendering display commands that cause the display device 112 to highlight the special notice symbol 214. It will be appreciated that the manner in which the special notice symbol 214 is highlighted may vary.

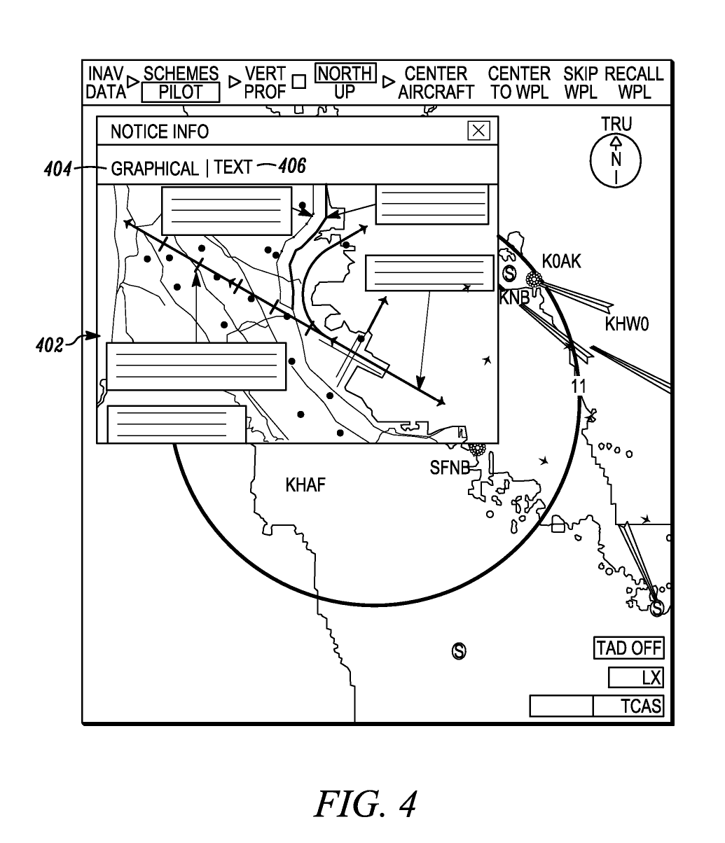

In addition to the above, if, after the cursor symbol 302 is placed over at least a portion of a rendered special notice symbol 214, the user 109 selects the special notice symbol 214 via, for example, the user interface 102, a selection signal is supplied from the user interface 102 to the processor 104. The processor 104 is configured, upon receipt of the selection signal, to retrieve the special notice data from, for example, the special notice database 118. The processor 104 is further configured, upon retrieval of the special notice data, to supply image rendering display commands to the display device 112 that cause the display device 112 to simultaneously render one or more images of the retrieved special notice data. It will be appreciated that the images may be rendered using various formats. For example, it may be rendered in a textual format only, a graphic format only, or a combination thereof. In the embodiment depicted in FIG. 4, the special notice data 402 is rendered in a combination of textual and graphic formats. As FIG. 4 also depicts, the special notice data 402 may be rendered with interactive text 404, 406 which allows the user 109 to select whether the special notice data 402 is rendered graphically, textually, or both.

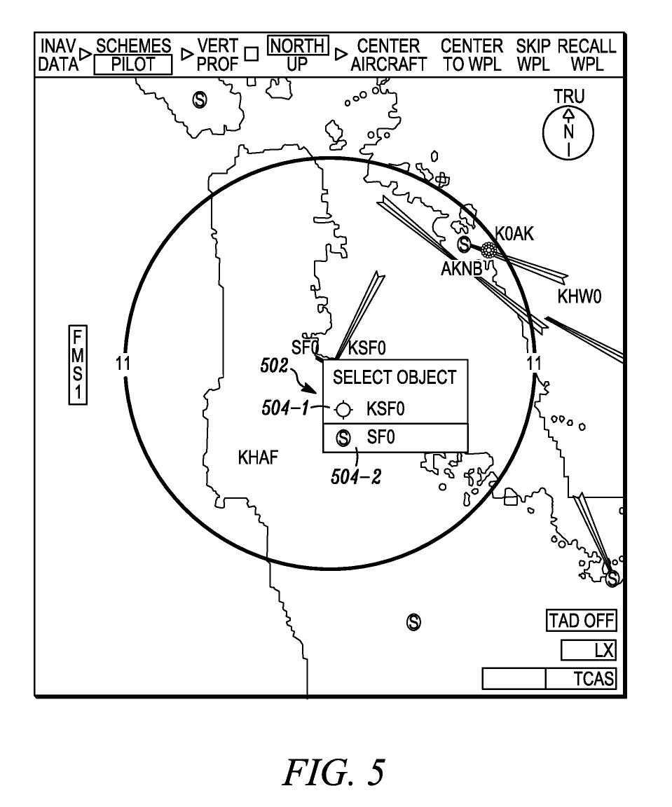

In some embodiments, the processor 104, upon receipt of the selection signal, may also supply image rendering display commands to the display device 112 that cause the display device 112 to simultaneously render an image of a menu. For example, and with reference now to FIG. 5, a rendered menu 502 is depicted that includes a plurality of selectable items 504 (e.g., 504-1, 504-2). Although two selectable items 504 are depicted in the exemplary image shown in FIG. 5, it will be appreciated that the menu 502 may be rendered with more or less than this number of selectable items 504. In any case, in the depicted image the selectable items 504 include a first selectable item 504-1 and a second selectable item 504-2. The first selectable item 504-1 may be used to display various navigation information and data associated with, for example, an airport, waypoint, or other rendered navigation icon. In the depicted example, the rendered icon represents a particular airport, and thus the first selectable item 504-1, when selected, may be used to display various navigation information and data associated with that airport.

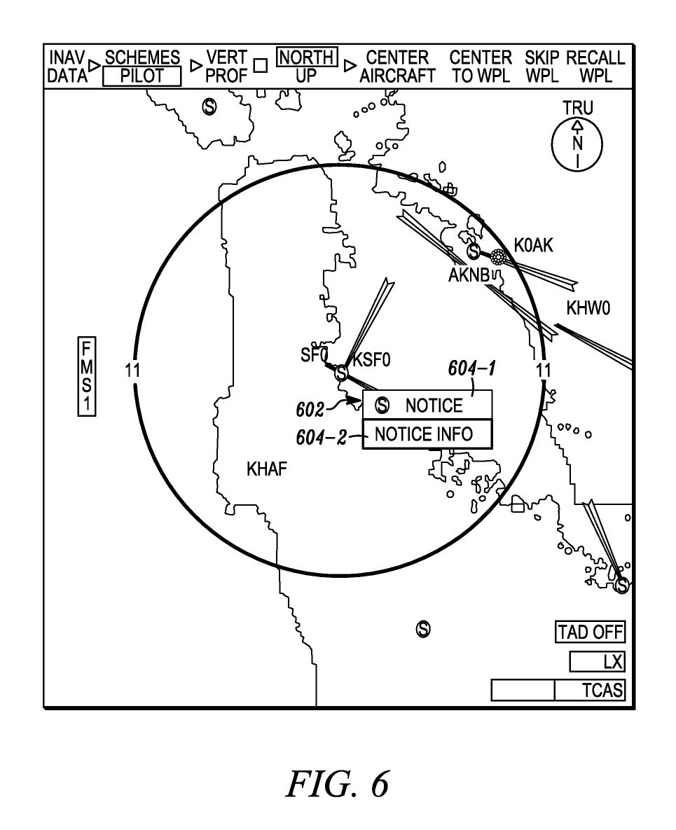

The second selectable item 504-2, as may be appreciated, may be used to display one or more images of the appropriate special notice data. It will be appreciated that, upon selection of the second selectable item 504-2, the processor 104 may command the display device 112 to render the appropriate special notice data. Alternatively, as depicted in FIG. 6, the processor 104 may command the display device 112 to render a sub-menu 602. The sub-menu 602, at least in the depicted embodiment, also includes a plurality of selectable items 604 (e.g., 604-1, 604-2). If a user selects the first selectable item 604-1 of the sub-menu 602, then the processor 104 will command the display device 112 to once again render the main menu 502 depicted in FIG. 5. If, however, the user selects the second selectable item 604-2 of the sub-menu 602, then the processor 104 will command the display device 112 to render one or more images of the special notice data, in the manner described above and depicted in FIG. 3.

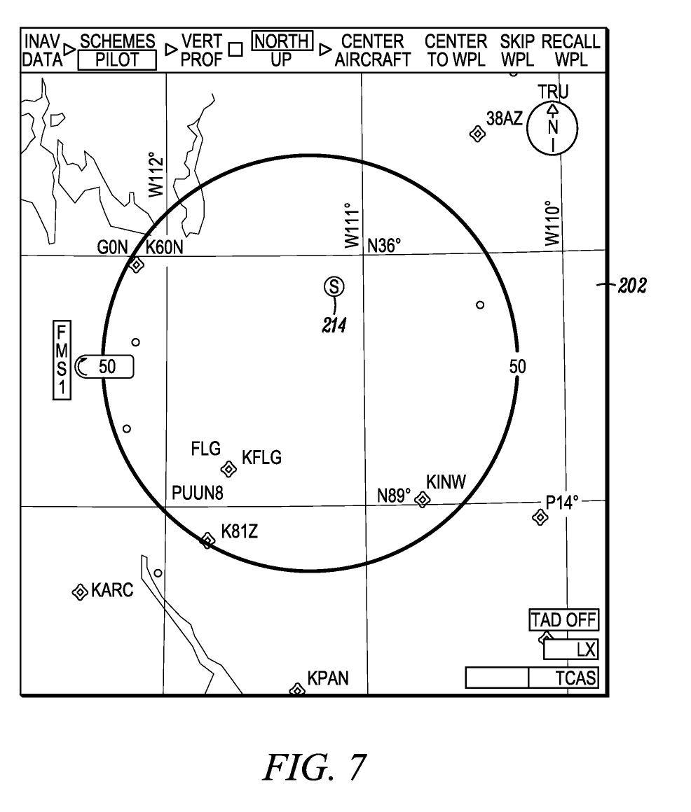

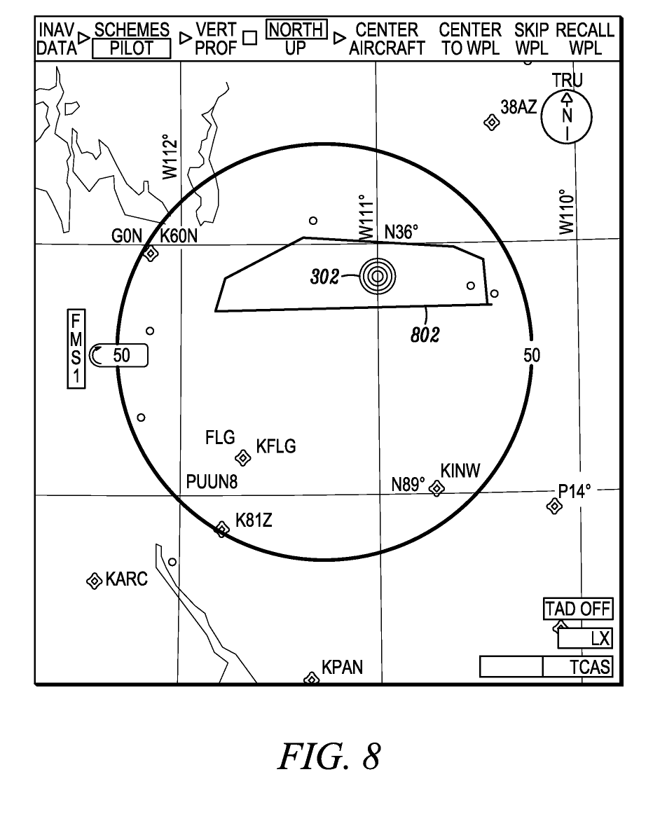

Turning now to FIG. 7, another exemplary image of a two-dimensional lateral situation view of terrain 202 and various navigation aids is depicted, along with a special notice symbol 214. The special notice symbol 214, in this case, is used to indicate that one or more special notices are associated with particular airspace. To determine the particular airspace with which one or more special notices are associated, the user preferably moves the cursor 302 over at least a portion of the rendered special notice symbol 214. When the user does this, and as is depicted in FIG. 8, the processor 104 commands the display device 112 to render an image of the particular airspace 802 with which one or more special notices are associated. The specific special notice(s) may be viewed as previously described herein.

In addition to the above, in which one or more special notice symbols 214 are described as being rendered on the image that is being viewed by a pilot, the system 100 may also be configured to alert the pilot about one or more impending special notices within (or near) the present aircraft flight plan/path. For example, if the processor 104 determines that aircraft, upon proceeding in accordance with the current flight plan, will fly into or near airspace and/or to or near an airport or other navigation aid/waypoint having special notice data associated therewith, then the processor 104 will command the display device 112 to render an appropriate alert. The alert that the processor 104 commands the display device 112 to render may vary, but in a particular preferred embodiment the processor 104 commands the display device 112 to render a flashing special notice symbol 214.

No matter the specific manner in which the system 100 alerts the pilot regarding one or more impending special notices 214, it will be appreciated that the system 100 is preferably configured to render the alert when the aircraft is within a preset distance from the particular airspace, airport, navigation aid/waypoint the associated special notice data. It will additionally be appreciated that the preset distance may vary, and that the system 100 may be configured such that the preset distance is selectable by the pilot. Moreover, the processor 104 may use data supplied from one or more of the sensors 106 to determine if or when the aircraft is within the preset distance.

The system and method described herein may be used to not only alert aircraft flight crews regarding the existence of special notice data during flight, but may also be used to alert flight crews before a flight while the aircraft flight plan is being prepared.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of selectively displaying special notices on a display device, the method comprising the steps of:
selectively retrieving navigation data;
processing the retrieved navigation data;
determining if at least a portion of the retrieved navigation data has special notice data associated therewith; and
rendering an image on a display device that (i) is representative of at least a portion of the retrieved navigation data, and (ii) includes a special notice icon if it is determined that at least a portion of the retrieved navigation data has special notice data associated therewith,
wherein the special notice data are representative of special notices normally published in an airport facility/directory.

2. The method of claim 1, further comprising:
selectively retrieving, from a special notice database, the special notice data associated with the retrieved navigation data; and
simultaneously rendering one or more images of the retrieved special notice data on the display device.

3. The method of claim 2, wherein the one or more images of the retrieved special notice data selectively include textual images, graphical images, or both.

4. The method of claim 2, further comprising:
retrieving the special notice data from the special notice database in response to a selection signal supplied from a user interface.

5. The method of claim 1, further comprising:
simultaneously rendering an image, on the display device, of a cursor on the display device; and
highlighting the special notice icon if the cursor is placed over at least a portion of the special notice icon.

6. The method of claim 5, further comprising:
selectively and simultaneously rendering an image, on the display device, of a menu associated with the special notice icon, the menu including a plurality of selectable items.

7. The method of claim 5, further comprising:
simultaneously highlighting portions of the rendered image if the cursor is placed over at least a portion of the special notice icon.

8. The method of claim 1, further comprising:
processing sensor data to determine aircraft position;
selectively retrieving terrain data based in part on the determined aircraft position;
processing the retrieved terrain data; and
simultaneously rendering an image that is representative of the processed terrain data.

9. A display system, comprising:
a display device coupled to receive image rendering display commands and operable, in response thereto, to render an image;
a processor adapted to selectively retrieve navigation data and configured to determine if at least a portion of the retrieved navigation data has special notice data associated therewith, the processor further configured to supply image rendering display commands to the display device that cause the display device to render an image that:
(i) is representative of at least a portion of the retrieved navigation data, and
(ii) includes a special notice symbol if it is determined that at least a portion of the retrieved navigation data has special notice data associated therewith,
wherein special notice data are representative of special notices normally published in airport facility and directory books.

10. The system of claim 9, further comprising:
a special notice database in operable communication with the processor and having the special notice data stored therein.

11. The system of claim 9, wherein the processor:
is in operable communication with the special notice database;
is further operable to selectively retrieve the special notice data associated with the retrieved navigation data from the special notice database; and
upon retrieval of special notice data, is further operable to supply image rendering display commands to the display device that cause the display device to simultaneously render one or more images of the retrieved special notice data on the display device.

12. The system of claim 11, wherein the one or more images of the retrieved special notice data selectively include textual images, graphical images, or both.

13. The system of claim 11, further comprising:
a user interface in operable communication with the processor, the user interface adapted to receive input from a user and configured, upon receipt of input from a user, to supply at least a selection signal to the processor,
wherein the processor is further configured, upon receipt of the selection signal, to retrieve the special notice data from the special notice database.

14. The system of claim 13, wherein the processor further supplies image rendering display commands to the display device that cause the display device to:
simultaneously render an image of a cursor on the display device; and
highlight the special notice icon if the cursor is placed over at least a portion of the special notice icon.

15. The system of claim 14, wherein the processor is further configured, if the cursor is placed over at least a portion of the special notice icon, to at least selectively supply image rendering display commands to the display device that cause the display device to simultaneously highlight portions of the rendered image.

16. The system of claim 13, wherein:
the processor is further configured, upon receipt of the selection signal, to at least selectively supply image rendering display commands to the display device that cause the display device to simultaneously render an image of a menu associated with the special notice icon; and
the rendered menu includes a plurality of selectable items.

17. The system of claim 9, further comprising:
a navigation database in operable communication with the processor and having the navigation data stored therein.

18. The method of claim 9, further comprising:
a sensor suite in operable communication with the processor and configured to supply sensor data,
wherein the processor is further configured, upon receipt of the sensor data, to determine aircraft position.

19. The system of claim 18, wherein the processor is further configured to:
selectively retrieve terrain data based in part on the determined aircraft position; and
supply image rendering display commands to the display device that cause the display device to simultaneously render an image that is representative of the processed terrain data.

20. The system of claim 19, further comprising:
a terrain database in operable communication with the processor and having the terrain data stored therein.
